(19) United States
(12) Patent Application Publication
(10) Pub. No.: US 2020/0236864 A1
(43) Pub. Date: Jul. 30, 2020

(54) STACKING VERTICAL GARDEN SYSTEM AND METHOD OF USE

(71) Applicant: Joseph Henry, Arlington, TX (US)

(72) Inventor: Joseph Henry, Arlington, TX (US)

(21) Appl. No.: 16/724,275

(22) Filed: Dec. 21, 2019

Related U.S. Application Data
(60) Provisional application No. 62/783,898, filed on Dec. 21, 2018.

(51) Int. Cl. A01G 9/02; A01G 27/00

(52) U.S. Cl. CPC A01G 9/023; A01G 27/008; A01G 27/005

(57) ABSTRACT

A stackable vertical garden system includes a base to hold and receive water, a rotation system engaged with the base and having a motor engaged with a first gear and a second gear, a bearing system having an inner race rigidly attached to the second gear and an outer race to remain stationary; the motor causes rotational movement of the inner race; a stacking base to engage with the inner race such that the stacking base rotates; a stationary brace engaged with the stacking base to receive a water source; and a first plant holder engaged with the stacking base, the first plant holder having plant receivers; a water chamber extending vertically through the stacking base and first plant holder to transfer water to a top of the stackable vertical garden system; a power source connects to the motor for rotation of the stackable base.

### BACKGROUND

### 1. Field of the Invention

The present invention relates generally to vertical gardens, and more specifically, to a stackable vertical garden system with an improved rotation system of the tower.

### 2. Description of Related Art

Vertical garden systems are well known in the art and are effective means to have a plurality of plants in a compact space. For example, FIG. 1 depicts a conventional vertical garden system 101 having a plant tower 103 with a plurality of plant receivers 104 extending from a base 105. During use, water is transferred from the base up through the tower to water the plants.

One of the problems commonly associated with system 101 is movement of the system. For example, the user will have to manually rotate the system in order to ensure that all plants receive adequate sunlight. This can be difficult due to the size and weight of the system.

Accordingly, although great strides have been made in the area of vertical garden systems, many shortcomings remain.

It is an object of the present invention to provide a vertical garden system that is stackable and modular, thereby allowing for the user to customize the size of tower they want. In addition, the system provides for rotational movement of the tower, while the base remains stationary and while preventing cords, water hoses, and the like from becoming tangled. The system thereby provides for an improved vertical garden system in which a control system controls water flow as well as rotation, thereby eliminating most user involvement with the system.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a common vertical garden system;

FIG. 2 is a front view of a vertical garden system in accordance with a preferred embodiment of the present application;

FIG. 3 is a cross sectional view of the vertical garden system of FIG. 2;

FIG. 4 is an isometric view of a rotation system of FIG. 2;

FIG. 5 is a cross sectional view of a bearing system of FIG. 4;

FIG. 6 is a cross sectional view of the rotation system of FIG. 4;

FIG. 7 is an isometric view of the rotation system of FIG. 2 showing a stationary brace;

FIG. 8 is a cross sectional view of a portion of the rotation system of FIG. 4;

FIG. 9 is a cross sectional view of a base of FIG. 1;

FIG. 10 is a cross sectional view of a first plant holder of FIG. 1; and

FIG. 11 is a simplified schematic of a control system associated with the present invention.

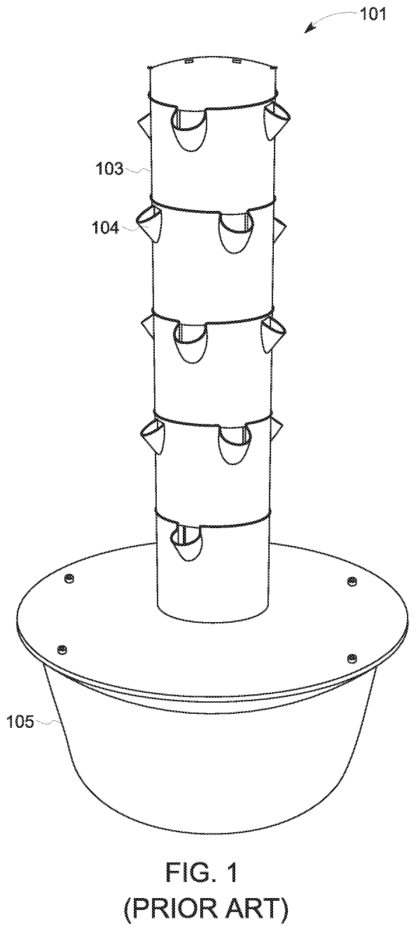

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional vertical garden systems. Specifically, the present invention provides for smooth rotation of the tower, as well as a stackable/modular capability that provides for improved user functionality and customization. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

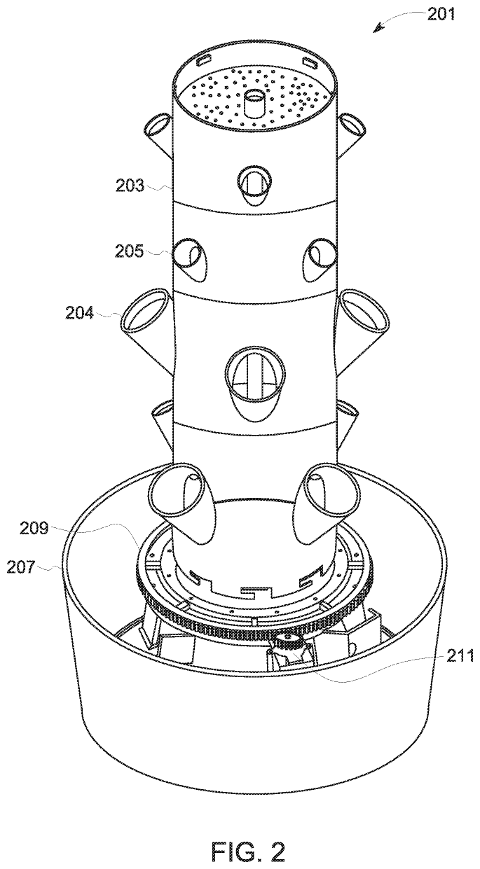

Referring now to the drawings wherein like reference characters identify corresponding or similar elements throughout the several views, FIG. 2 depicts a front view of a stackable vertical garden system in accordance with a preferred embodiment of the present application. It will be appreciated that system 201 overcomes one or more of the above-listed problems commonly associated with conventional vertical garden systems.

In the contemplated embodiment, system 201 includes a tower 203 with a plurality of plant receivers 204, 205 which can vary in size and location. In the preferred embodiment, the plant receivers 204, 205 are positioned at an angle, thereby providing for easy securement of plants in the receivers. It should also be appreciated that the shape of the receivers can also vary.

In the preferred embodiment, the tower 203 is secured above a base 207 which is configured to hold and recycle water through the tower via a pump not shown. The base 207 can vary in size and shape as desired. System 201 further includes a rotation system 209 engaged with a motor box 211 and one or more gears. The rotation system provides a means to rotate the tower, while the base remains stationary.

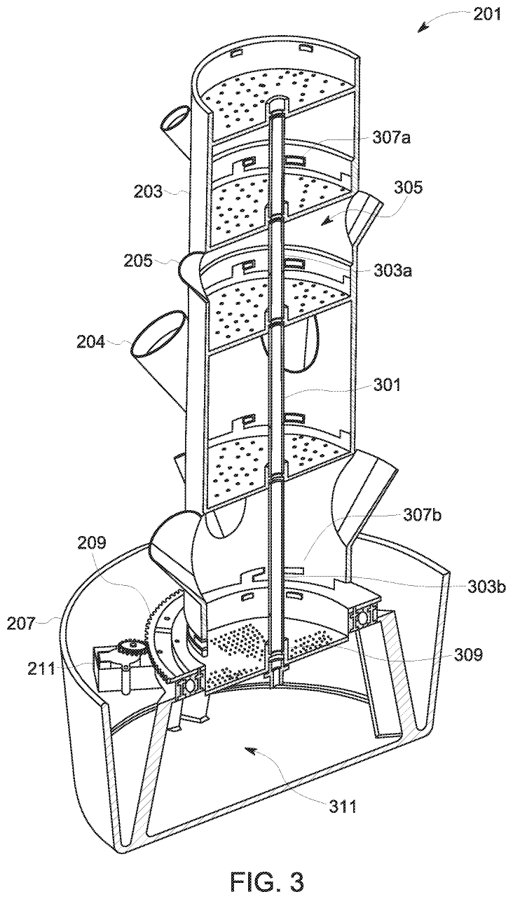

In FIG. 3, a cross sectional view of system 201 is shown. It should be appreciated that FIG. 3 has some details removed to provide for clarify, however, these details will be described in detail later on. System 201 further includes a water chamber 301, which can be in a plurality of segments 303 extending through the tower and configured to facilitate water movement through the tower to water the plant roots extending therein. The tower is composed of one or more plant holders, each being connectable to make the system modular in style. System 201 includes an interior chamber 305 within each of the plant holders into which roots of plants extend and water is transferred. It should be appreciated that the interior chamber 305 can also be adapted for holding a soil.

In the preferred embodiment, the system is stackable via one or more attachment mechanism 307a-b, which will be described later on. It should further be appreciated that the system includes an attachment 309 which provides for a location to connect chamber 301 to a water source to receive water from interior area 311 of base 207.

In the preferred embodiment, the water runs up the center of the plant holders and is added per plan holder, allowing plant holders to be added individually as desired. The water showers down through the plan holders watering the roots. A pump (not shown) can be positioned within the base to provide pumping of the water through the system. The tower can be place in areas of non-symmetrical light, such as against a wall, and the system provides for rotation to maintain even light exposure to all plants. This rotation can be controlled via a control system. The base provides a water reservoir, the pump will turn on and off periodically to keep the roots moist. Depending on the size of the base, type of plants growing and number of plants growing the water base should need topping up about once per week. This provides convenience that plants remain alive when a house is left unattended.

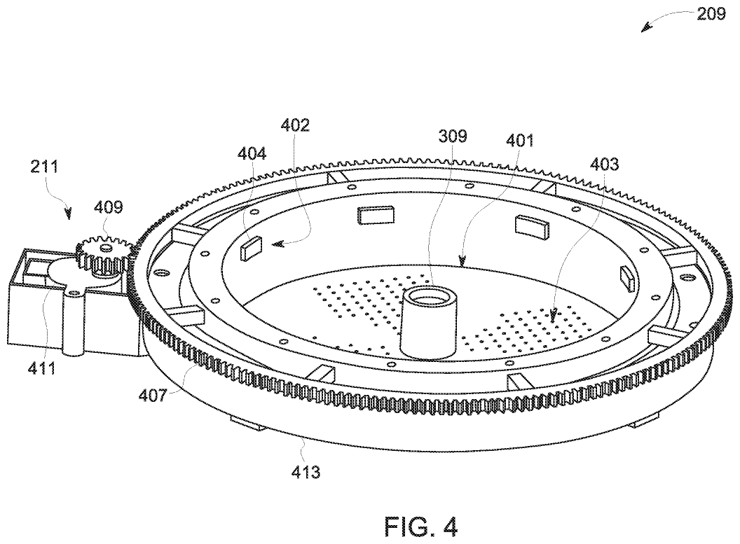

In FIG. 4, an isometric view of a rotation system 209 is shown. System 209 includes motor box 211, which houses a first gear 409 and a motor 411, which can be in communication with a control system (not shown). Gear 409 engages with gear 407 which is attached to an inner race of a bearing system 413 via an inner circumference. The rotation system 209 further includes a stacking base 401 with integral walls 402 and a permeable bottom 403 for the transfer of water. Attachment 309 is further shown, as well as attachment mechanism 404 for securing the stacking base 401 to a first plant holder.

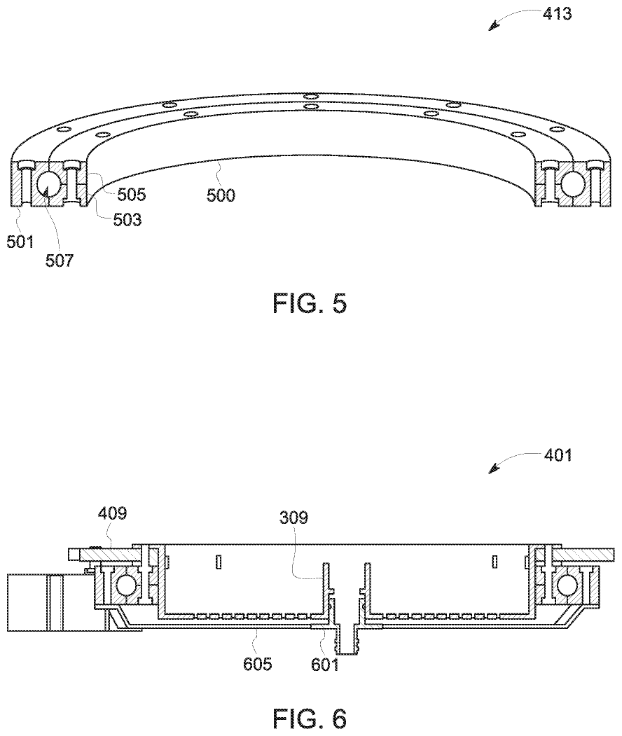

In FIG. 5, a cross sectional view of a bearing system 413 is shown. Bearing system 413 includes an inner race 500 having a top 505 and a bottom 503, and includes an outer race 501, wherein a circular channel 507 is formed between the inner race and the outer race. It should be appreciated that a plurality of bearings are housed within the channel 507 which provides for smoothed and balanced rotation of the tower above the base via the motor and gear system.

In FIG. 6, the stacking base 401 is further shown. Stacking base 401 is in communication with gear 409, such that the stacking base is rotated. As shown, a water source connection 601 is attached to a stationary brace 605. The water source connection 601 can include one or more O-rings to ensure a tight fit with a water source, such as a hose. In one embodiment, the hose pushes onto the connection 601 which is ribbed to stop it sliding off. The connection fits into the stack base and has an O-ring to prevent leaks. The point of movement is between the hose connector upper section and stack base at the O-ring, like a garden hose connector.

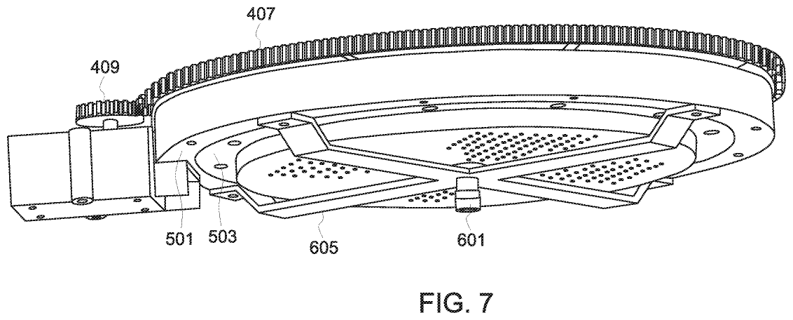

As better shown in FIG. 7, the stationary brace 605 secures to outer race 501. This ensures that the water source does not rotate, as the tower rotates. This feature is believed unique to the present invention as it ensures that the tower can rotate without the water source, wires, or the like becoming tangled. It should be appreciated that as the motor rotates the first gear, the second gear rotates the inner race, which is engaged with the stacking base, which is further engaged with the rest of the tower and causes rotation of the entire tower. This provides for smooth rotation, while the outer race, stationary brace, and water source remain still.

In FIG. 8, another cross-sectional view of gear 407 is shown. Gear 407 can include an inner circumference 805 which is attached to the inner race. As further shown, a housing 801 can house the motor 411 as well as a control system.

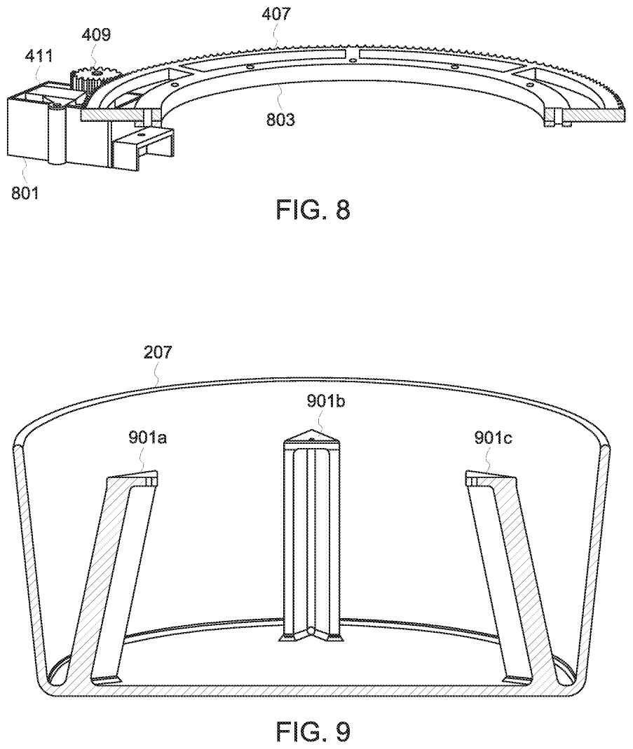

In FIG. 9, a cross sectional view of base 207 is shown having a plurality of supports 901 to engage with the rotation system. It should be appreciated that the shape and configuration of the supports can vary.

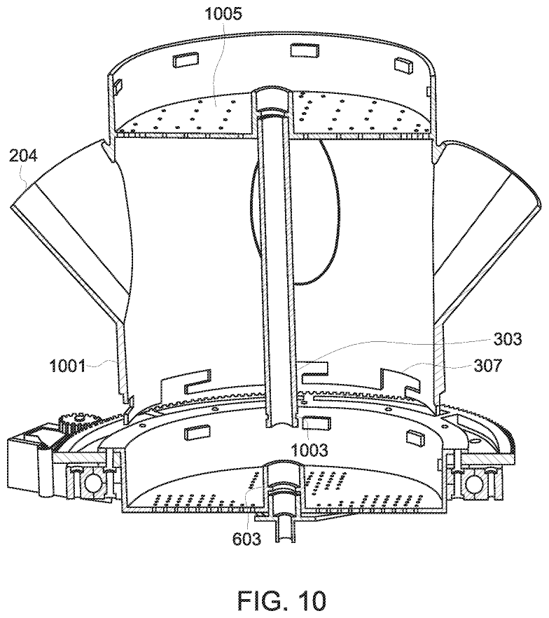

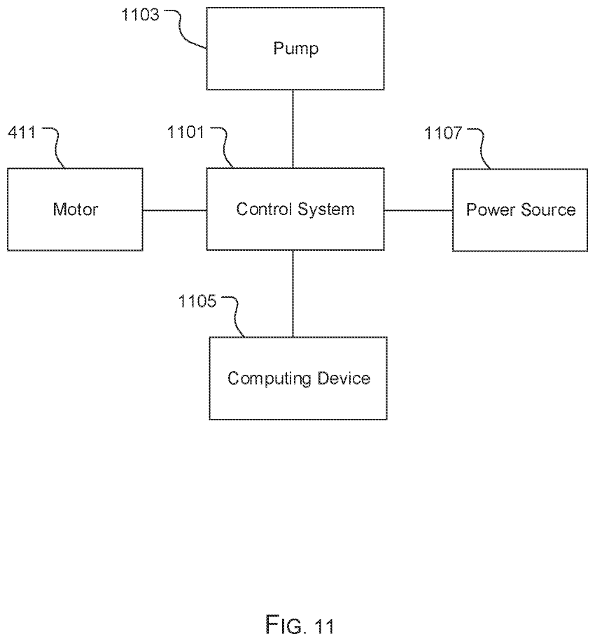

In FIG. 10, a partial cross-sectional view of a first plant holder 1001 is shown. It should be appreciated that the system is configured to be modular, wherein a plurality of holders can be stacked together to a desired height. Holder 1001 includes an attachment 1003 to engage with attachment 309. As shown, the system is modular via a plurality of attachment mechanisms 307. Although the precise configuration can vary, one contemplated means is a tab and groove style attachment that allows for the plant holders to secure together. Each plant holder is engaged with a permeable surface 1005, which allows for water to be transferred to the top of the tower and flow through the tower to the base to be recycled and used again.

In FIG. 11, a simplified schematic depicts a control system 1101 for use with system 201. Control system 1101 can be in communication with a pump 1103 for pumping water through the tower, motor 411 for controlling rotation, and in some embodiments, a computing device 1105 which can be used to remotely control the system. It is contemplated that in some embodiments, the computing device 1105 can be a mobile device configured for wireless communication with the control system 1101. Control system, and associated components, can receive power from a power source 1107, such as a battery, through an outlet, through an alternative power source such as solar, or the like. The control system provides for near automation of the system.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A stackable vertical garden system, comprising:
a base configured to hold and receive water, the base having one or more supports;
a rotation system engaged with the base and having:
a motor engaged with a first gear;
a second gear engaged with the first;
a bearing system having an inner race rigidly attached to the second gear and an outer race configured to remain stationary;
wherein the motor causes rotational movement of the inner race;
a stacking base configured to engage with the inner race such that the stacking base rotates with the inner race, the stacking base having:
a permeable bottom; and
a side wall extending from the permeable bottom;
a stationary brace engaged with the stacking base and configured to receive a water source; and
a first plant holder channel engaged with the stacking base, the first plant holder having side walls and one or more plant receivers extending from the side walls;
a water chamber extending vertically through the stacking base and first plant holder and configured to transfer water from the water source to a top of the stackable vertical garden system;
wherein a power source connects to the motor for rotation of the stackable base.

2. The system of claim 1, wherein the stackable base and first plant holder are removably engaged via an attachment mechanism.

3. The system of claim 1, wherein the first plant holder further comprises:
a permeable top; and
an exterior top wall that includes an attachment mechanism to receive a second plant holder;
wherein the system is modular via additional plant holders.

4. The system of claim 3, wherein the attachment mechanism is a tab and groove attachment.

5. The system of claim 1, wherein the stationary brace includes a stationary hose attachment.

6. The system of claim 1, wherein the bearing system further comprises:
the inner race having a top half and a bottom half; and
a circular channel formed between the inner race and the outer race and configured to receive a plurality of bearings;
wherein the bearing system provides smooth rotation.

7. The system of claim 1, further comprising:
a control system in communication with the motor and in further communication with a pump housed in the base;
wherein the control system is configured to control rotation and water transfer.
